(19) United States
(12) Patent Application Publication
(10) Pub. No.: US 2024/0116013 A1
(43) Pub. Date: Apr. 11, 2024

(54) PROCESSING SYSTEM AND METHOD FOR PROCESSING AN ENERGY STORAGE MATERIAL

(71) Applicant: Coperion GmbH, Stuttgart (DE)

(72) Inventors: Markus FIEDLER, Wiernsheim (DE); Johannes HEYN, Altbach (DE)

(73) Assignee: Coperion GmbH, Stuttgart (DE)

(21) Appl. No.: 18/376,233

(22) Filed: Oct. 3, 2023

(30) Foreign Application Priority Data
Oct. 5, 2022 (EP) 22 199 811.5

(51) Int. Cl. B01F 27/1143; B01F 27/723; B01F 27/724; B29B 7/46

(52) U.S. Cl. CPC B01F 27/1143; B01F 27/723; B01F 27/724; B29B 7/46; B01F 2215/0431

(57) ABSTRACT

In a processing system for processing an energy storage material, a pressure buildup device is disposed downstream of a mixing device. The mixing device serves for the processing of the energy storage material. By means of the pressure buildup device, a pressure of the energy storage material is increased for a subsequent shaping. Because the mixing device and the pressure buildup device are separate from one another, a good mixing effect and a good pressure buildup effect are achieved. The energy storage material can thus be processed in a high quality in a simple and reliable manner. The energy storage material serves in particular for the production of bipolar plates for fuel cells and/or for the production of galvanic energy storage devices.

### CROSS-REFERENCES TO RELATED APPLICATIONS

This application claims the priority of European Patent Application, Serial No. EP 22 199 811.5, filed Oct. 5, 2022, the content of which is incorporated herein by reference in its entirety as if fully set forth herein.

### FIELD OF THE INVENTION

The invention relates to a processing system and a method for processing an energy storage material.

Energy storage materials are required for the production of bipolar plates for fuel cells and for the production of galvanic energy storage devices, such as accumulators or batteries.

### BACKGROUND OF THE INVENTION

DE 10 2009 051 434 A1 discloses a method for producing a flat web made of an energy storage material. The flat web serves, for example, for the production of bipolar plates for fuel cells. An extruder is fed with starting materials, which are mixed to form the energy storage material. Disposed at the outlet of the extruder is a slot die through which the energy storage material provided in the extruder is extruded under high pressure. Downstream of the slot die, the energy storage material is in the form of a flat web.

### SUMMARY OF THE INVENTION

It is an object of the invention to provide a processing system that allows simple and reliable processing of an energy storage material in a high quality.

This object is achieved by a processing system for processing an energy storage material comprising a mixing device for processing the energy storage material, wherein a pressure buildup device is disposed downstream of the mixing device in order to increase a pressure of the energy storage material. It has been recognized in accordance with the invention that a high quality of the energy storage material requires not only a good mixing effect for mixing of starting materials, but also a good pressure buildup effect for a subsequent shaping. A mixing device can be optimized either in terms of its mixing effect or in terms of its pressure buildup effect, and so the quality of the energy storage material is not satisfactory in each of the cases described.

Therefore, the processing system according to the invention has a separate pressure buildup device which is disposed downstream of the mixing device. Preferably, the mixing device has a conveying direction. The pressure buildup device is in particular disposed downstream of the mixing device in the conveying direction. Because the mixing device and the pressure buildup device are separate from one another, the mixing effect and the pressure buildup effect can be optimized independently of one another, and so an energy storage material is producible in high quality in a simple and reliable manner. The mixing device is optimized in terms of its mixing effect and allows improved mixing of the fed-in starting materials to form the energy storage material. The mixture or the energy storage material produced is then fed to the pressure buildup device. The pressure buildup device is optimized in terms of its pressure buildup effect and generates a high pressure in the energy storage material for subsequent shaping. The pressure buildup device serves in particular for continuous execution of a pressure buildup in the energy storage material.

The pressure buildup device comprises in particular a pressure buildup screw machine and/or a gear pump. Preferably, the pressure buildup device makes it possible to achieve a pressure increase Δp, where in particular: 1 bar≤Δp≤2000 bar, in particular 5 bar≤Δp≤1000 bar, and in particular 10 bar≤Δp≤500 bar.

The shaping is done by means of an extrusion tool, for example a slot die. The extrusion tool is disposed downstream of the pressure buildup device. Preferably, the processing system comprises an extrusion tool which is disposed downstream of the pressure buildup device.

The processing system, in particular the mixing device, serves in particular for continuous processing of an energy storage material. Preferably, the mixing device defines a first conveying direction for the energy storage material and/or the pressure buildup device defines a second conveying direction for the energy storage material. The second conveying direction runs in particular parallel and/or transversely, in particular perpendicular, to the first conveying direction. The second conveying direction therefore runs at an angle between 0° and 90° to the first conveying direction. The pressure buildup device is in particular disposed downstream of the mixing device in the first conveying direction. An extrusion tool is in particular disposed downstream of the pressure buildup device in the second conveying direction.

A processing system in which the mixing device comprises a processing screw machine, ensures simple and reliable processing of an energy storage material in a high quality. The processing screw machine allows a good mixing effect. The starting materials are mixed and homogenized in a simple manner by means of the processing screw machine. A pressure buildup is only necessary for conveying the energy storage material to the pressure buildup device.

Preferably, the processing screw machine comprises a housing in which at least one housing bore is formed. A respective treatment element shaft is rotatably disposed in the at least one housing bore. The respective treatment element shaft has a profile which has in particular one to ten flights, in particular one to four flights, preferably two to three flights. Preferably, the processing screw machine is designed as a multi-shaft processing screw machine. The multi-shaft processing screw machine comprises in particular a housing in which at least two housing bores are formed. The at least two housing bores penetrate one another, especially at least in pairs. A treatment element shaft is disposed in each of the at least two housing bores. The multi-shaft processing screw machine thus comprises at least two treatment element shafts. The at least two treatment element shafts are preferably in an intermeshing design and/or arrangement. The at least two treatment element shafts are oriented parallel to one another and/or conically to one another. In particular, axes of rotation associated with the at least two treatment element shafts run parallel to one another and/or run conically to one another or inclined at an angle to one another. The at least two treatment element shafts have an external diameter D_{A}, which can be constant and/or variable along a length L_{A} of the at least two treatment element shafts. The external diameter D_{A} can in particular be reduced along the length L_{A}, and so the at least two treatment element shafts are conical. Preferably, the mixing device comprises a two-shaft processing screw machine.

The multi-shaft processing screw machine is preferably designed as a co-rotating processing screw machine or as a counter-rotating processing screw machine. A co-rotating processing screw machine has at least two treatment element shafts rotating in the same direction. In contrast, a counter-rotating processing screw machine has at least two treatment element shafts rotating in opposite directions.

The processing screw machine is preferably designed as a co-rotating multi-shaft processing screw machine, in particular as a two-shaft processing screw machine.

Preferably, the mixing device comprises exactly one multi-shaft processing screw machine, in particular exactly one two-shaft processing screw machine. The processing screw machine thus has an optimal mixing effect. A co-rotating multi-shaft processing screw machine is axially open and allows in principle a backflow of the energy storage material. Because the co-rotating multi-shaft processing screw machine is not primarily utilized for pressure buildup, the energy storage material does not accumulate or only backs up slightly in the co-rotating multi-shaft processing screw machine. Excessive backup prior to discharge as a result of a pressure buildup would be disadvantageous, since more mechanical energy would be introduced into the energy storage material, thereby increasing the temperature of the energy storage material undesirably and degrading the energy storage material.

The mixing device can comprise one processing screw machine or multiple processing screw machines. Multiple processing screw machines can be identical and/or different. Multiple processing screw machines can be disposed one after the other or in series with one another and/or disposed parallel to one another. Preferably, multiple processing screw machines are disposed parallel to one another. This makes it possible to achieve variable throughputs and/or different throughputs with different extrusion tools. Downtimes during changes in formulation, during maintenance and/or during cleaning can be minimized.

A processing system in which the processing screw machine comprises at least one treatment element shaft having a length L_{A} and an external diameter D_{A}, where: 20≤L_{A}/D_{A}≤60, in particular 25≤L_{A}/D_{A}≤56, and in particular 30≤L_{A}/D_{A}≤52, ensures simple and reliable processing of an energy storage material in a high quality. The L_{A}/D_{A} ratio of the processing screw machine allows a good mixing effect and homogenization effect.

A processing system in which the pressure buildup device comprises a pressure buildup screw machine, ensures simple and reliable processing of an energy storage material in a high quality. The pressure buildup screw machine serves in particular for continuous execution of a pressure buildup in the energy storage material. The pressure buildup screw machine has an improved pressure buildup effect. The flowable energy storage material discharged from the mixing device is fed to the pressure buildup screw machine. Preferably, the pressure buildup screw machine has exclusively an intake zone and a pressure buildup zone.

The pressure buildup screw machine has in particular at least one pressure buildup treatment element shaft. The pressure buildup effect of the pressure buildup screw machine can be optimized in particular by a slope or a conveying angle of the at least one pressure buildup treatment element shaft, a number of flights and/or a flight depth of the at least one pressure buildup treatment element shaft and/or a land width and/or a land clearance of the at least one pressure buildup treatment element shaft. For example, the pressure buildup effect is increased, the smaller the slope or the conveying angle, the smaller the flight depth, the smaller the number of flights and/or the smaller the land clearance. Preferably, a clearance of the active flank and/or the passive flank is as small as possible.

The pressure buildup screw machine has a single shaft or is designed as a single-shaft pressure buildup screw machine or has multiple shafts or is designed as a multi-shaft pressure buildup screw machine. A multi-shaft pressure buildup screw machine has in particular two shafts. The multi-shaft pressure buildup screw machine is counter-rotating or co-rotating.

Preferably, the pressure buildup screw machine is designed as a single-shaft pressure buildup screw machine or as a counter-rotating multi-shaft pressure buildup screw machine, in particular as a counter-rotating two-shaft pressure buildup screw machine.

The pressure buildup device can comprises one pressure buildup screw machine or multiple pressure buildup screw machines. Multiple pressure buildup screw machines can be identical and/or different. Multiple pressure buildup screw machines can be disposed one after the other or in series with one another and/or disposed parallel to one another. Preferably, multiple pressure buildup screw machines are disposed parallel to one another. This makes it possible to achieve variable throughputs and/or different throughputs with different extrusion tools. Downtimes during changes in formulation, during maintenance and/or during cleaning can be minimized.

A processing system in which the pressure buildup screw machine comprises at least one pressure buildup treatment element shaft having a length L_{D} and an external diameter D_{D}, where: 3≤L_{D}/D_{D}≤40, in particular 4≤L_{D}/D_{D}≤20, and in particular 5≤L_{D}/D_{D}≤10, ensures simple and reliable processing of an energy storage material in a high quality. The L_{D}/D_{D} ratio allows a high pressure buildup in a simple manner. Preferably, the pressure buildup screw machine comprises exclusively an intake zone for feeding the flowable energy storage material and a pressure buildup zone for increasing the pressure in the flowable energy storage material. Since the pressure buildup screw machine merely has to provide a pressure buildup effect, a compact design of the pressure buildup screw machine is possible. The L_{D}/D_{D} ratio of the pressure buildup screw machine is in particular smaller than an L_{A}/D_{A} ratio of a processing screw machine, where L_{A} denotes a length and D_{A} an external diameter of the at least one treatment element shaft of the processing screw machine.

A processing system in which the pressure buildup device comprises a single-shaft pressure buildup screw machine, ensures simple and reliable processing of an energy storage material in a high quality. The pressure buildup screw machine has single shaft, i.e. is designed as a single-shaft pressure buildup screw machine. The single-shaft pressure buildup screw machine comprises a housing in which a housing bore is formed. A pressure buildup treatment element shaft, in particular a pressure buildup screw element shaft, is rotatably disposed in the housing bore. The pressure buildup treatment element shaft preferably has a profile which has one to ten flights, in particular two to four flights. The single-shaft pressure buildup screw machine allows a high pressure buildup, since the backflow or leakage flow of the energy storage material between the inner wall of the housing and the ridges of the pressure buildup treatment element shaft is low.

A processing system in which the pressure buildup device comprises a multi-shaft pressure buildup screw machine, ensures simple and reliable processing of an energy storage material in a high quality. The pressure buildup screw machine has multiple shafts, i.e. is designed as a multi-shaft pressure buildup screw machine. The multi-shaft pressure buildup screw machine is counter-rotating or co-rotating. The multi-shaft pressure buildup screw machine comprises a housing in which at least two housing bores are formed. A pressure buildup treatment element shaft, in particular a pressure buildup screw element shaft, is disposed in each of the at least two housing bores. The at least two pressure buildup treatment element shafts, in particular the at least two pressure buildup screw element shafts, have a profile which has in particular one to ten flight, in particular one to four flights, and in particular two to three flights. In the case of a counter-rotating multi-shaft pressure buildup screw machine, the at least two treatment element shafts are rotationally disposed in the at least two housing bores in opposite directions of rotation. In the case of a co-rotating multi-shaft pressure buildup screw machine, the at least two pressure buildup treatment element shafts are rotationally disposed in the at least two housing bores in the same directions of rotation. The at least two housing bores intersect one another, especially at least in pairs. Preferably, the multi-shaft pressure buildup screw machine is designed as a two-shaft pressure buildup screw machine.

The counter-rotating multi-shaft pressure buildup screw machine has a self-contained chamber conveyance, and so the backflow or leakage flow of the energy storage material is low, thereby allowing a high pressure buildup in a simple manner. The mechanical energy input into the energy storage material is low during pressure buildup.

The co-rotating multi-shaft pressure buildup screw machine merely has to be configured for pressure buildup, and so a co-rotating multi-shaft pressure buildup screw machine can also allow a good pressure buildup which is also realizable without an undesirably high mechanical energy input into the energy storage material. The co-rotating multi-shaft pressure buildup screw machine has in particular at least two pressure buildup treatment element shafts having a profile which has one to ten flights. A one-flight profile is particularly suitable for pressure buildup.

If the pressure buildup device comprises a multi-shaft pressure buildup screw machine, a processing screw machine is preferably disposed at the side of the unscrewing pressure buildup treatment element shaft. The at least two pressure buildup treatment element shafts can be disposed vertically or horizontally to one another. In the case of a pressure buildup screw machine having at least two vertically disposed pressure buildup treatment element shafts, the processing screw machine can be disposed in an interstitial region of the pressure buildup screw machine.

A processing system in which the pressure buildup screw machine comprises an intake zone and a pressure buildup zone, ensures simple and reliable processing of an energy storage material in a high quality. The pressure buildup screw machine has a housing in which at least one housing bore is formed. A pressure buildup treatment element shaft, in particular a pressure buildup screw element shaft, is rotatably disposed in each case in the at least one housing bore. In the intake zone, a feed opening is formed in the housing. The feed opening serves for feeding of the flowable energy storage material into the at least one housing bore. The flowable energy storage material is conveyed to the pressure buildup zone in a conveying direction. In the pressure buildup zone, the pressure in the flowable energy storage material is increased. In the pressure buildup zone, a discharge opening is formed in the housing. The flowable energy storage material is discharged through the discharge opening under high pressure. Preferably, the pressure buildup screw machine has exclusively an intake zone and a pressure buildup zone. The pressure buildup zone is disposed downstream of the intake zone in a conveying direction of the pressure buildup screw machine.

A processing system in which the mixing device comprises a processing screw machine having at least one treatment element shaft and the pressure buildup device comprises a pressure buildup screw machine having at least one pressure buildup treatment element shaft, wherein for a ratio of an external diameter D_{A} of the at least one treatment element shaft to an external diameter D_{D} of the at least one pressure buildup treatment element shaft: ⅕≤D_{A}/D_{D}≤3, in particular ⅓≤D_{A}/D_{D}≤2, and in particular ½≤D_{A}/D_{D}≤1, ensures simple and reliable processing of an energy storage material in a high quality.

For a multi-shaft processing screw machine and a single-shaft pressure buildup screw machine, in particular:

⅕≤D_{A}/D_{D}≤2, and in particular ⅓≤D_{A}/D_{D}≤1.

For a multi-shaft, in particular two-shaft, processing screw machine and a multi-shaft, in particular two-shaft, pressure buildup screw machine, in particular:

⅕≤D_{A}/D_{D}≤3, and in particular ½≤D_{A}/D_{D}≤2.

A processing system in which the mixing device has at least one discharge opening which is disposed above a feed opening of the pressure buildup device, ensures simple and reliable processing of an energy storage material in a high quality. Because the at least one discharge opening of the mixing device is disposed above the feed opening of the pressure buildup device based on the direction of gravity, the flowable energy storage material can be fed to the pressure buildup device in a simple manner. The feeding of the energy storage material is effected by means of gravity, and in particular without pressure. Preferably, the mixing device comprises multiple discharge openings for generation of strands of the energy storage material. For this purpose, the mixing device preferably comprises a discharge plate or perforated plate having multiple discharge openings for generation of strands of energy storage material. Alternatively, an open transfer of the energy storage material without a perforated plate is possible.

Preferably, the processing system comprises at least one blade for shredding of the strands produced. The at least one blade can be rotationally drivable by means of a drive and/or stationary. The at least one blade and the associated drive form a shredding unit for shredding of the strands produced. As a result, the feeding of the energy storage material to the pressure buildup device is simplified, since the length of the strands of energy storage material produced is adjustable in a desired manner, and so feed problems or intake problems in the case of the pressure buildup device can be avoided. Shredding of the strands is effected, for example, by hot cutting. The at least one blade can rotate and/or oscillate centrically or eccentrically in relation to the discharge plate or perforated plate. The shredding unit is in particular integrated into a connecting device for connection of the mixing device and the pressure buildup device.

A processing system in which a connecting device is disposed between the mixing device and the pressure buildup device in order to feed the energy storage material to the pressure buildup device, ensures simple and reliable processing of an energy storage material in a high quality. The connecting device is in particular attached to the mixing device and/or to the pressure buildup device. The connecting device leads in particular to the pressure buildup device, in particular to a housing of a pressure buildup screw machine, from above and/or from the side in relation to a direction of gravity.

The connecting device comprises in particular a temperature-control unit for temperature-adjustment or heating and/or cooling of the flowable energy storage material and/or a degassing unit for degassing of the flowable energy storage material. Preferably, at least one sensor for measuring at least one property of the energy storage material is disposed in and/or on the connecting device. Preferably, the connecting device comprises at least one connecting element. The at least one connecting element is formed, for example, by a pipe and/or a closed shaft. The at least one connecting element can be vacuum-tight and be connected to a degassing unit. Such an enclosure in relation to the environment prevents contamination and/or moisture absorption from the environment. Volatile compounds and/or water or water vapor can be extracted by suction.

The at least one connecting element or the respective connecting element has an internal diameter D_{V}, where preferably: 0.5≤D_{V}/D_{A}≤10, in particular 0.8≤D_{V}/D_{A}≤5, and in particular 1≤D_{V}/D_{A}≤2, where D_{A} denotes an external diameter of at least one treatment element shaft of a processing screw machine. Preferably, the at least one connecting element or the respective connecting element has a length L_{V}, where: 1≤L_{V}/D_{A}≤100, in particular 2≤L_{V}/D_{A}≤50, and in particular 4≤L_{V}/D_{A}≤10, where D_{A} denotes an external diameter of at least one treatment element shaft of a processing screw machine.

Preferably, the at least one connecting element is telescopic. The at least one connecting element or the respective connecting element comprises in particular at least two components which are displaceable relative to one another in order to compensate for thermal expansion. Preferably, the connecting device comprises an insulation surrounding the at least one connecting element.

The at least one connecting element is in particular straight and/or curved. In the case of a curvature, a radius of curvature R_{V} is in particular: 0.5≤R_{V}/D_{A}≤10, in particular 1≤R_{V}/D_{A}≤7, and in particular 2≤R_{V}/D_{A}≤4. In the case of a curvature, an angle of curvature α between connected straight sections of the at least one connecting element is in particular: 1°≤α≤90°, in particular 5°≤α≤70°, and in particular 10°≤α≤50°.

The connecting device serves in particular for division of the flowable energy storage material into multiple strands. Preferably, the connecting device is designed such that the energy storage material discharged from the mixing device is divided into N partial streams, where in particular: 1≤N≤8, in particular 2≤N≤6, and in particular 3≤N≤4.

A processing system in which the mixing device and the pressure buildup device are connected to one another in order to feed the energy storage material to the pressure buildup device, ensures simple and reliable processing of an energy storage material in a high quality. The mixing device and the pressure buildup device are directly connected to one another. Preferably, a housing of the mixing device, in particular a housing of a processing screw machine, is connected to a housing of the pressure buildup device, in particular to a housing of a pressure buildup screw machine. Preferably, the mixing device is connected to the side of the pressure buildup device. In particular, at least one housing bore of a processing screw machine leads to at least one housing bore of a pressure buildup screw machine. Preferably, the mixing device comprises a processing screw machine having at least one treatment element shaft and the pressure buildup device comprises a pressure buildup screw machine having at least one pressure buildup treatment element shaft. In a feed zone in which the at least one housing bore of the processing screw machine leads to the at least one housing bore of the pressure buildup screw machine, the at least one treatment element shaft has a distance s from the nearest pressure buildup treatment element shaft, where in particular: 0.05 mm≤s≤10·D_{A}, in particular 0.1 mm≤s≤10·D_{A}, in particular 0.1 mm≤s≤5·D_{A}, and in particular 0.5 mm≤s≤D_{A}, where D_{A} denotes an external diameter of the at least one treatment element shaft.

A processing system in which an extrusion tool is disposed downstream of the pressure buildup device, ensures simple and reliable processing of an energy storage material in a high quality. The extrusion tool serves for the shaping or forming of the energy storage material and/or for the coating of a support film with the energy storage material. The support film is in particular directly coated. The support film is in particular formed as a metallic and/or polymer-based film Because the extrusion tool is disposed immediately downstream of the pressure buildup device in a conveying direction of the pressure buildup device, a high pressure is available for shaping of the energy storage material. The extrusion tool is in particular slot-shaped, for example in the form of a slot-shaped die. The extrusion tool preferably has a maximum discharge width b, where: 5 mm≤b≤2000 mm, in particular 50 mm≤b≤1500 mm, and in particular 100 mm≤b≤1000 mm.

The extrusion tool preferably has a discharge thickness d, where in particular: 0.01 mm≤d≤10 mm, in particular 0.05≤d≤5 mm, and in particular 0.1 mm≤d≤2 mm.

The higher the pressure generated by means of the pressure buildup device, the thinner and wider the energy storage material can be shaped by means of an extrusion tool. The higher the viscosity of the flowable energy storage material, the more pressure that is required to shape the energy storage material by means of an extrusion tool.

Following the extrusion tool, the energy storage material preferably has a plate shape and/or a film shape.

It is a further object of the invention to provide a method that allows simple and reliable processing of an energy storage material in a high quality.

This object is achieved by a method for processing an energy storage material comprising the steps of:
providing a processing system for processing an energy storage material,
processing the energy storage material by means of the mixing device,
discharging the energy storage material from the mixing device and feeding the energy storage material to the pressure buildup device,
increasing a pressure of the energy storage material by means of the pressure buildup device, and
discharging the energy storage material from the pressure buildup device.

The advantages of the method according to the invention correspond to the advantages of the processing system according to the invention that have already been described. The method according to the invention can in particular be developed with at least one feature which has been described in connection with the processing system according to the invention. Preferably, the method serves for the processing of energy storage materials for bipolar plates and/or for the processing of solvent-containing energy storage materials and/or for the processing of solvent-free energy storage materials. Such energy storage materials are used in particular in fuel cells and/or galvanic energy storage devices, for example in accumulators and/or batteries. The energy storage material is in particular electrically conductive.

A filler content of the energy storage material is in particular between 50% by weight and 99.5% by weight, in particular between 70% by weight and 99% by weight, and in particular between 80% by weight and 98.5% by weight.

A formulation for an energy storage material for the production of bipolar plates comprises in particular:
85% by weight to 98% by weight of a filler and
2% by weight to 15% by weight of a binder.

The filler is especially selected from the group of graphite, carbon black, graphene, carbon nanotubes (CNT), multi-walled carbon nanotubes (MWCNT) and/or carbon fibres.

The binder is especially selected from the group of thermoplastic (amorphous and/or semi-crystalline), for example PP, PE, PA, PBT, PPS, PEEK, PEAK), thermoplastic elastomer, for example TPA, TPC, TPO, TPS, TPU, TPV, polymer blends, for example PP/TPO, PA/TPO. In addition, additives and/or stabilizers can be added to the formulation, for example heat stabilizers, UV stabilizers, crosslinkers, adhesion promoters and/or lubricants.

A formulation for a solvent-containing energy storage material comprises for example:
50% by weight to 99.5% by weight of filler or active material and
0.5% by weight to 50% by weight of solvent.

The filler or the active material is especially selected from the group of graphite, graphene, silicon, carbon nanotubes (CNT), multi-walled carbon nanotubes (MWCNT), lithium nickel manganese cobalt oxides, lithium cobalt oxide, lithium manganese oxide spinel, lithium iron phosphate, lithium nickel cobalt aluminium oxide, lithium titanate oxide, silicon, lithium-aluminium alloy, lithium-magnesium alloy, lithium-silicon alloy, lithium-tin alloy, lithium hexafluorophosphate, lithium polysulfide, lithium metal polysulfide, lithium lanthanum zirconate and/or lithium lanthanum titanium oxide.

The solvent is especially selected from the group of demineralized water, N-methyl-2-pyrrolidone (NMP), N-ethyl-2-pyrrolidone (NEP) and/or triethyl phosphate (TEP).

A formulation for a solvent-free energy storage material comprises for example:
80% by weight to 99.5% by weight of filler or active material and
0.5% by weight to 20% by weight of at least one polymer and/or at least one binder.

The filler or the active material is especially selected from the group of graphite, graphene, silicon, carbon nanotubes (CNT), multi-walled carbon nanotubes (MWCNT), lithium nickel manganese cobalt oxides, lithium cobalt oxide, lithium manganese oxide spinel, lithium iron phosphate, lithium nickel cobalt aluminium oxide, lithium titanate oxide, silicon, lithium-aluminium alloy, lithium-magnesium alloy, lithium-silicon alloy, lithium-tin alloy, lithium hexafluorophosphate, lithium polysulfide, lithium metal polysulfide, lithium lanthanum zirconate and/or lithium lanthanum titanium oxide.

The at least one polymer is especially selected from the group of PTFE, PVDF and/or PEO. With respect to the at least one binder, reference is made to the foregoing.

A solvent-free energy storage material can in particular comprise: polymer-based materials, oxide-based materials and/or thiophosphate-based materials. In addition, a solvent-free energy storage material can comprise additives.

Preferably, the mixing device comprises a processing screw machine and/or the pressure buildup device comprises a pressure buildup screw machine. The processing screw machine is in particular operated at a speed n_{A}, where: 1 rpm≤n_{A}≤2000 rpm, in particular 50 rpm≤n_{A}≤1600 rpm, and in particular 100 rpm≤n_{A}≤1200 rpm. The pressure buildup screw machine is in particular operated at a speed n_{D}, where: 1 rpm≤n_{D}≤300 rpm, in particular 2 rpm≤n_{D}≤200 rpm, and in particular 3 rpm≤n_{D}≤150 rpm.

For a multi-shaft processing screw machine and a single-shaft pressure buildup screw machine, in particular: 3≤n_{A}/n_{D}≤500, in particular 5≤n_{A}/n_{D}≤150, and in particular 10≤n_{A}/n_{D}≤90.

For a multi-shaft processing screw machine and a multi-shaft pressure buildup screw machine, in particular: 4≤n_{A}/n_{D}≤200, in particular 15≤n_{A}/n_{D}≤120, and in particular 30≤n_{A}/n_{D}≤90.

Preferably, a calender and/or an embossing unit and/or a coating unit is disposed downstream of the extrusion tool. As a result, a calendering process and/or an embossing process and/or a coating process can be carried out downstream of the extrusion tool.

Further features, advantages and details of the invention will be apparent from the following description of multiple exemplary embodiments.

### BRIEF DESCRIPTION OF THE DRAWING

FIG. 1 shows a partially cut side view of a processing system for processing an energy storage material according to a first exemplary embodiment comprising a mixing device which comprises a co-rotating two-shaft processing screw machine, a pressure buildup device which comprises a single-shaft pressure buildup screw machine and a connecting device which comprises a closed shaft,

FIG. 2 shows a partially cut plan view of the processing system in FIG. 1,

FIG. 3 shows a partially cut plan view of a processing system for processing an energy storage material according to a second exemplary embodiment, wherein a single-shaft pressure buildup screw machine is disposed at an angle of 90° to a co-rotating two-shaft processing screw machine,

FIG. 4 shows a partially cut plan view of a processing system for processing an energy storage material according to a third exemplary embodiment, wherein the mixing device comprises a co-rotating two-shaft processing screw machine and the pressure buildup device comprises a counter-rotating two-shaft pressure buildup screw machine,

FIG. 5 shows a partially cut plan view of a processing system for processing an energy storage material according to a fourth exemplary embodiment, wherein a counter-rotating two-shaft pressure buildup screw machine is disposed at an angle of 90° to a co-rotating two-shaft processing screw machine,

FIG. 6 shows a partially cut plan view of a processing system for processing an energy storage material according to a fifth exemplary embodiment, wherein a co-rotating two-shaft processing screw machine is directly connected to a single-shaft pressure buildup screw machine,

FIG. 7 shows a partially cut plan view of a processing system for processing an energy storage material according to a sixth exemplary embodiment, wherein a co-rotating two-shaft processing screw machine is directly connected to a counter-rotating two-shaft pressure buildup screw machine,

FIG. 8 shows a partially cut side view of a processing system for processing an energy storage material according to a seventh exemplary embodiment, wherein a co-rotating two-shaft processing screw machine is directly connected to a counter-rotating two-shaft pressure buildup screw machine and pressure buildup treatment element shafts are vertically disposed on top of one another, and

FIG. 9 shows a partially cut side view of a processing system for processing an energy storage material according to an eighth exemplary embodiment, wherein a connecting device between a co-rotating two-shaft processing screw machine and a single-shaft pressure buildup screw machine comprises a pipe.

### DESCRIPTION OF THE PREFERRED EMBODIMENTS

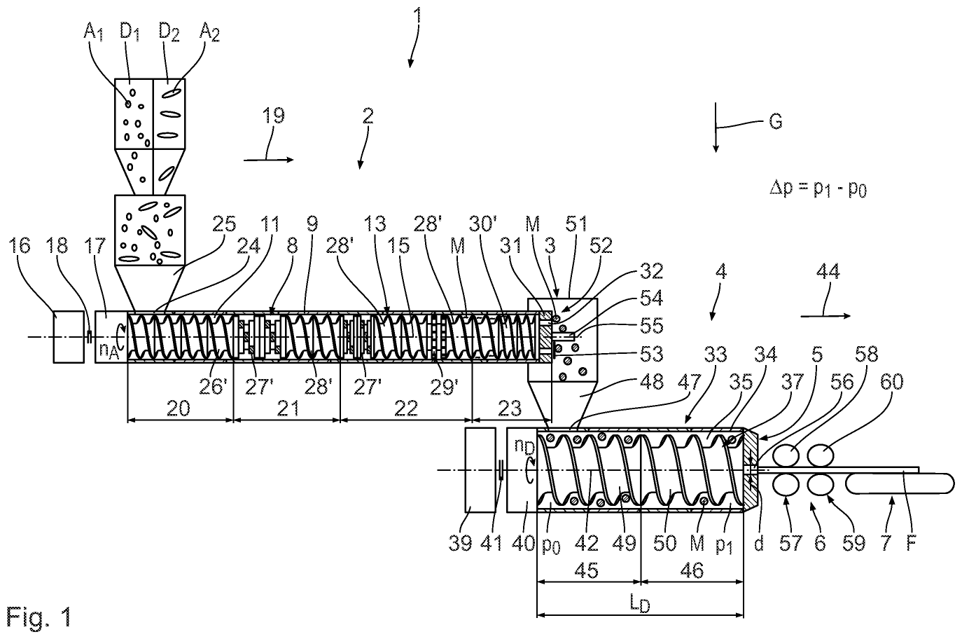

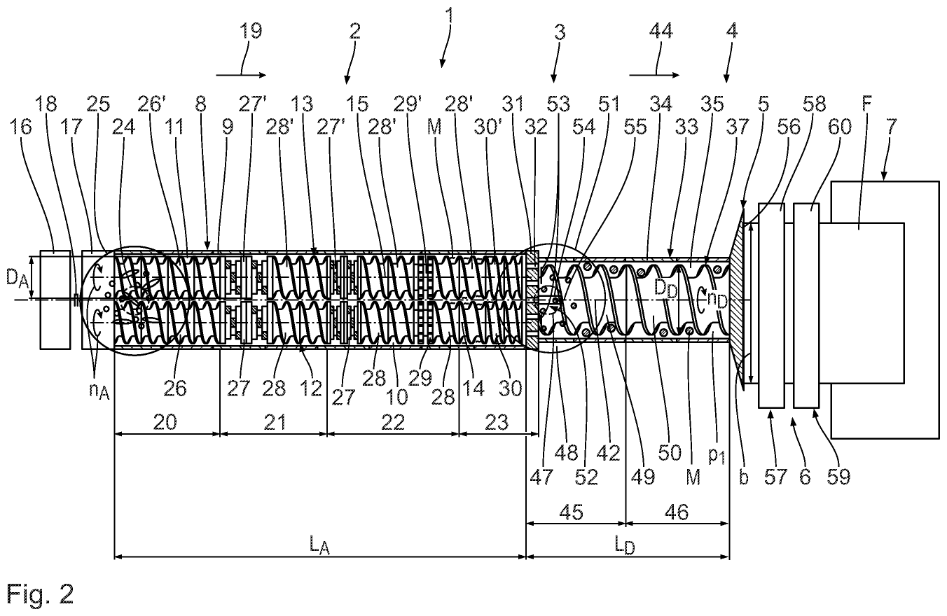

A first exemplary embodiment of the invention is described in the following with reference to FIGS. 1 and 2. The processing system 1 depicted in FIGS. 1 and 2 serves for the continuous processing of an energy storage material M. The energy storage material M is a mixture of at least two starting materials A₁ and A₂. The energy storage material M serves for the production of bipolar plates for fuel cells and/or for the production of galvanic energy storage devices, such as accumulators and batteries. The energy storage material M is electrically conductive. Produced in particular from the energy storage material M are shaped articles F which are further processed as semi-finished products. The shaped articles F are, for example, in the form of plates and/or films.

The processing system 1 comprises a mixing device 2, a connecting device 3, a pressure buildup device 4, an extrusion tool 5, a reworking device 6 and a transport device 7.

The mixing device 2 comprises a processing screw machine 8 which is designed as a co-rotating multi-shaft processing screw machine or co-rotating two-shaft processing screw machine. The processing screw machine 8 comprises a housing 9 in which there are formed two housing bores 10, 11 which are parallel to one another and penetrate one another. The housing bores 10, 11 have the shape of a horizontal eight in cross-section. Disposed in the housing bores 10, 11 are two treatment element shafts 12, 13 which are rotationally drivable around associated axes of rotation 14, 15 in the same directions of rotation. Rotational driving is achieved by the mixing device 2 comprising a drive motor 16 and a distribution transmission 17, between which there is disposed a coupling 18. The treatment element shafts 12, 13 are rotationally driven around the axes of rotation 14, 15 in the same directions of rotation by means of the drive motor 16 via the distribution transmission 17.

The processing screw machine 8 comprises a discharge plate 31 which closes the housing 9. The discharge plate 31 has multiple discharge openings 32. The discharge plate 31 is thus in the form of a perforated plate.

The processing screw machine 8 has a first conveying direction 19. In the first conveying direction 19, the processing screw machine 8 forms in succession an intake zone 20, a melting zone 21 or a melting and mixing zone, a mixing and homogenization zone 22 and a discharge zone 23. In the intake zone 20, the housing 9 has a feed opening 24. Leading to the feed opening 24 is a feed hopper 25. The processing screw machine 8 can have further feed openings along the housing 9. Feeding can be effected directly into the housing 9, in particular by means of a feed hopper, and/or by means of a feed screw machine, for example a side loading machine. Metered feeding of the starting materials A₁ and A₂ is achieved by the mixing device comprising two metering units D₁ and D₂. In the intake zone 20, the fed-in starting materials A₁ and A₂ are conveyed in the first conveying direction 19 to the melting zone 21 or the melting and mixing zone. For this purpose, the treatment element shafts 12, 13 in the feed zone 20 have screw elements or conveyor elements 26, 26′.

In the melting zone 21 or the melting and mixing zone, the meltable starting materials A₁, A₂ are melted or plasticized and homogenously mixed. For this purpose, the treatment element shafts 12, 13 in the melting zone 21 or the melting and mixing zone have kneading elements 27, 27′ and screw elements or conveyor elements 28, 28′. The kneading elements 27, 27′ comprise in particular kneading blocks having integrally interconnected kneading discs and/or individual kneading discs.

In the mixing and homogenization zone 22, the melted meltable starting materials A₁, A₂, for example solids and solvents, are mixed and homogenized to yield a homogeneous mixture. The homogeneous mixture is the energy storage material M. The energy storage material M is flowable. In the mixing and homogenization zone 22, the treatment element shafts 12, 13 have kneading elements 27, 27′ and mixing elements 29, 29′ and screw elements or conveyor elements 28, 28′. The kneading elements 27, 27′ and/or the mixing elements 29, 29′ comprise in particular kneading blocks having multiple integrally interconnected kneading discs and/or individual kneading discs.

In the discharge zone 23, the energy storage material M is conveyed to the discharge plate 31. In the discharge zone 23, the treatment element shafts 12, 13 have screw elements or conveyor elements 28, 28′ and 30, 30′.

The treatment element shafts 12, 13 have a length L_{A} in the first conveying direction 19. Furthermore, the treatment element shafts 12, 13 have an external diameter D_{A}. For a ratio of the length L_{A} to the external diameter D_{A}: 20≤L_{A}/D_{A}≤60, in particular 25≤L_{A}/D_{A}≤56, and in particular 30≤L_{A}/D_{A}≤52.

The pressure buildup device 4 serves for increasing of a pressure p of the energy storage material M. The pressure buildup device 4 is disposed downstream of the mixing device 2 in the first conveying direction 19.

The pressure buildup device 4 comprises a pressure buildup screw machine 33 which is designed as a single-shaft pressure buildup screw machine. The pressure buildup screw machine 33 comprises a housing 34 in which a housing bore 35 is formed. Disposed rotationally drivably in the housing bore 35 is a pressure buildup treatment element shaft 37. The pressure buildup device 4 comprises a drive motor 39 and a transmission 40. Disposed between the drive motor 39 and the transmission 40 is a coupling 41. The pressure buildup treatment element shaft 37 is rotationally drivable around an axis of rotation 42 by means of the drive motor 39 via the transmission 40 and the coupling 41. The housing 34 is closed by the extrusion tool 5.

The pressure buildup screw machine 33 has a second conveying direction 44. The second conveying direction 44 runs parallel to the first conveying direction 19. The processing screw machine 8 and the pressure buildup screw machine 33 are thus arranged or oriented at an angle of 0° to one another.

The pressure buildup screw machine 33 forms an intake zone 45 and a pressure buildup zone 46 in the second conveying direction 44.

In the intake zone 45, a feed opening 47 is formed in the housing 34. Leading to the feed opening 47 is a feed hopper 48. In the intake zone 45, the pressure buildup treatment element shaft 37 comprises at least one screw element 49. The energy storage material M has a first pressure p₀ when entering the intake zone 45. In the intake zone 45, the energy storage material M is conveyed to the pressure buildup zone 46.

In pressure buildup zone 46, the pressure p₀ of the energy storage material M is increased. At the extrusion tool 5, the energy storage material M has a pressure p₁. For a pressure increase Δp: Δp=p₁−p₀. In the pressure buildup zone 46, the pressure buildup treatment element shaft 37 has at least one screw element 50. The pressure buildup screw machine 33 thus has exclusively the intake zone 45 and the pressure buildup zone 46. Furthermore, the pressure buildup treatment element shaft 37 has exclusively screw elements 49, 50, and so it is designed as a pressure buildup screw element shaft.

The pressure buildup treatment element shaft 37 has a length L_{D} in the second conveying direction 44. Furthermore, the pressure buildup treatment element shaft 37 has an external diameter D_{D}. For a ratio of the length L_{D} to the external diameter D_{D}, in particular: 3≤L_{D}/D_{D}≤40, in particular 4≤L_{D}/D_{D}≤20, and in particular 5≤L_{D}/D_{D}≤10.

For a ratio of the external diameter D_{A} to the external diameter D_{D}, in particular: ⅕ ≤D_{A}/D_{D}≤3, in particular ⅓≤D_{A}/D_{D}≤2, and in particular ½≤D_{A}/D_{D}≤1.

For the pressure increase Δp, in particular: 1 bar≤Δp≤2000 bar, in particular 5 bar≤Δp≤1000 bar, and in particular 10 bar≤Δp≤500 bar.

For the pressure p₀ in FIG. 1, in particular: p₀≈pₐₜₘ, where pₐₜₘ, denotes the atmospheric pressure, which is approx. 1 bar.

For the pressure p₁ in FIG. 1, in particular: 1 bar≤p₁≤2000 bar.

The discharge openings 32 of the processing screw machine 8 are disposed above the feed opening 47 of the pressure buildup screw machine 33 in relation to the direction G of gravity. As a result, the energy storage material M falls into the feed hopper 48 owing to gravity after exiting from discharge openings 32.

The connecting device 3 comprises a connecting element 51 which is in the form of a closed shaft. The connecting element 51 is connected to the housing 9 and the feed hopper 48. The connecting device 3 can comprise a temperature-control unit and/or degassing unit, not shown in greater detail, which can be disposed in and/or on the connecting element 51. Integrated into the connecting device 3 is a shredding unit 52. The shredding unit 52 comprises a blade 53 which is rotationally drivable around an axis of rotation 55 by means of a drive 54. The shredding unit 52 serves for the shredding of the strands of energy storage material M passing out of the discharge openings 32.

The extrusion tool 5 is disposed downstream of the pressure buildup device 4 or downstream of the pressure buildup screw machine 33 in the second conveying direction 44. The extrusion tool 5 has a slot-shaped discharge opening 56 or a die opening. The discharge opening 56 has a discharge width b and a discharge thickness d. By means of the extrusion tool 5, the shaped article F is shaped or produced from the flowable energy storage material M. The shaped article F is in the form of a plate or film.

The reworking device 6 is disposed downstream of the extrusion tool 5 in the second conveying direction 44. The reworking device 6 serves for the reworking of the shaped article F. The reworking device 6 comprises a calender 57 having at least two calender rollers 58. The calender 57 can have a single stage or multiple stages. Furthermore, the reworking device 6 comprises an embossing unit 59 which is disposed downstream of the calender 57 in the second conveying direction 44. The embossing unit 59 comprises at least two embossing rollers 60. The transport device 7 is disposed downstream of the reworking device 6 in the conveying direction 44. The transport device 7 is designed, for example, as a conveyor belt.

The operation of the processing system 1 is as follows:

The starting materials A₁ and A₂ are fed to the feed hopper 25 by means of metering units D₁ and D₂. Through the feed hopper 25, the starting materials A₁ and A₂ reach the intake zone 20 of the processing screw machine 8 via the feed opening 24. In the processing screw machine 8, the starting materials A₁ and A₂ are conveyed to the melting zone 21 or the melting and mixing zone, where the meltable components are melted and mixed. In the mixing and homogenization zone 22, the starting materials A₁ and A₂ are processed into a homogeneous mixture. The homogeneous mixture forms the flowable energy storage material M. The energy storage material M is discharged in strands in the discharge zone 23 through the discharge openings 32 of the discharge plate 31. This only requires a low pressure in the discharge zone 23. The shredding unit 52 shreds the strands in a desired manner, and so the energy storage material M falls into the feed hopper 48 owing to gravity.

The energy storage material M is fed into the intake zone 45 of the pressure buildup screw machine 33 through the feed hopper 48 via the feed opening 47. The pressure buildup screw machine 33 conveys the energy storage material M from the intake zone 45 to the pressure buildup zone 46. What occurs in the pressure buildup screw machine 33, in particular in the pressure buildup zone 46, is pressure increase Δp. At the end of the pressure buildup zone 46, the energy storage material M is extruded at a high pressure p₁ through the extrusion tool 5. Owing to the slot-shaped discharge opening 56, the shaped article F is formed in a desired manner and it is reworked by means of the reworking device 6 in a desired manner and then transported away via the transport device 7.

The processing screw machine 8 is operated at a speed n_{A}, where: 1 rpm≤n_{A}≤2000 rpm, in particular 50 rpm≤n_{A}≤1600 rpm, and in particular 100 rpm≤n_{A}≤1200 rpm.

The pressure buildup screw machine 33 is operated at a speed n_{D}, where: 1 rpm≤n_{D}≤500 rpm, in particular 2 rpm≤n_{D}≤300 rpm, and in particular 3 rpm≤n_{D}≤150 rpm.

For a ratio of the speed n_{A} to the speed n_{D}, in particular: 3≤n_{A}/n_{D}≤500, in particular 5≤n_{A}/n_{D}≤150, and in particular 10≤n_{A}/n_{D}≤90.

Because the mixing device 2 and the pressure buildup device 4 are separate from one another, the processing or mixing of the energy storage material M and the pressure buildup in the energy storage material M are decoupled from one another. The mixing device 2 can therefore be optimized in terms of its mixing effect, whereas the pressure buildup device 4 can be optimized in terms of its pressure buildup effect. This provides in a simple and reliable manner a continuous single-stage processing method which ensures a high quality of an energy storage material M or of a shaped article F produced therefrom.

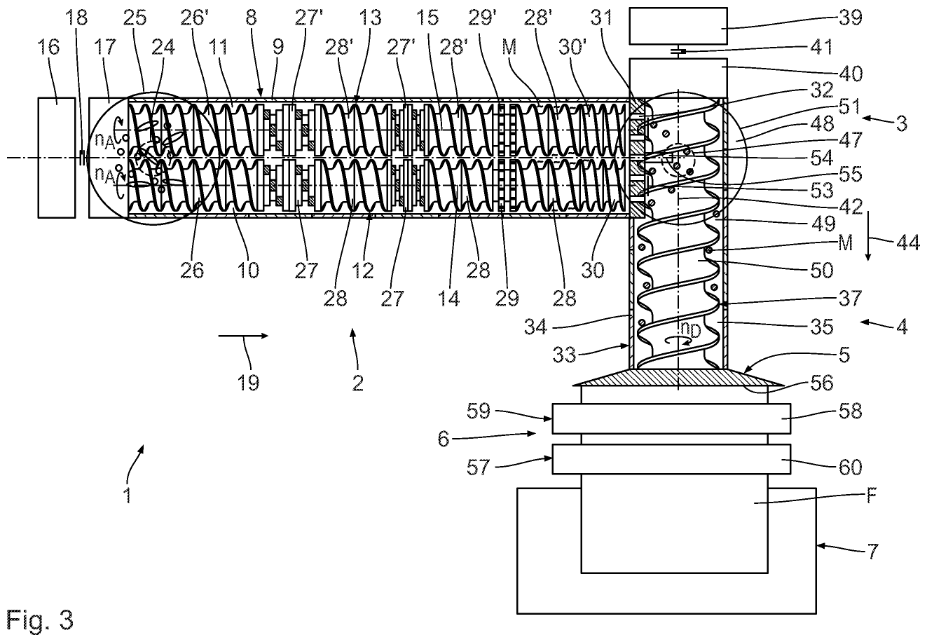

A second exemplary embodiment of the invention is described in the following with reference to FIG. 3. In contrast to the first exemplary embodiment, the pressure buildup device 4 is disposed at an angle of 90° relative to the mixing device 2. As a result, the second conveying direction 44 runs perpendicular to the first conveying direction 19. As a result, the processing system 1 has a shorter overall length and thus a more compact design. Because the feeding of the energy storage material M in the connecting device 3 occurs substantially without pressure and the pressure buildup in the energy storage material M occurs by means of the pressure buildup device 4, the L-shaped arrangement of the pressure buildup device 4 in relation to the mixing device 2 does not adversely affect pressure buildup. With respect to further details about the structure and operation of the processing system 1, reference is made to the preceding exemplary embodiment.

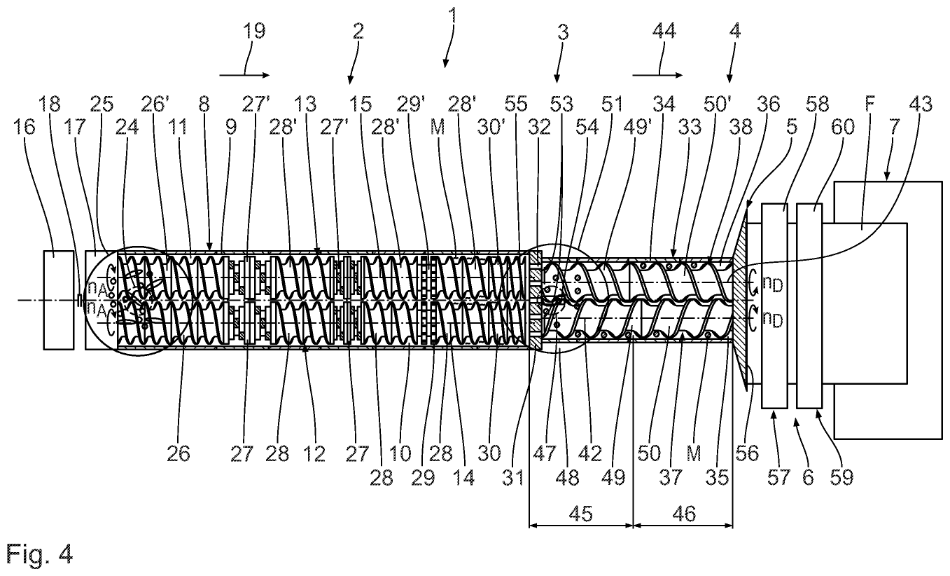

A third exemplary embodiment of the invention is described in the following with reference to FIG. 4. In contrast to the preceding exemplary embodiments, the pressure buildup screw machine 33 is designed as a counter-rotating multi-shaft pressure buildup screw machine. In particular, the pressure buildup screw machine 33 is designed as a counter-rotating two-shaft pressure buildup screw machine.

In the housing 34 of the pressure buildup screw machine 33, two housing bores 35, 36 which penetrate one another are formed. The housing bores 35, 36 have the shape of a horizontal eight in cross-section. The housing bores 35, 36 are disposed next to one another in a horizontal direction. Disposed rotatably in the housing bores 35, 36 are pressure buildup treatment element shafts 37, 38. In particular, the pressure buildup treatment element shafts 37, 38 have exclusively screw elements 49, 49′ and 50, 50′, and so they are designed as pressure buildup screw element shafts. The pressure buildup treatment element shafts 37, 38 are rotationally driven around axes of rotation 42, 43 in opposite directions of rotation by means of the drive motor 39 via the transmission 40 designed as a distribution transmission. The counter-rotating pressure buildup screw machine 33 has a chamber conveyance which is self-contained, and so a backflow or leakage flow of the energy storage material M in the housing bores 35, 36 is minimal. As a result, a good pressure buildup is possible in the pressure buildup zone 46 without mechanical energy being undesirably input into the energy storage material M.

The processing screw machine 8 is operated at a speed n_{A}, where: 1 rpm≤n_{A}≤2000 rpm, in particular 50 rpm≤n_{A}≤1600 rpm, and in particular 100 rpm≤n_{A}≤1200 rpm.

The pressure buildup screw machine 33 is operated at a speed n_{D}, where: 1 rpm≤n_{D}≤300 rpm, in particular 2 rpm≤n_{D}≤200 rpm, and in particular 3 rpm≤n_{D}≤150 rpm.

For a ratio of the speed n_{A} to the speed n_{D}, in particular: 4≤n_{A}/n_{D}≤200, in particular 15≤n_{A}/n_{D}≤120, and in particular 30≤n_{A}/n_{D}≤90.

With respect to further details about structure and operation, reference is made to the preceding exemplary embodiments.

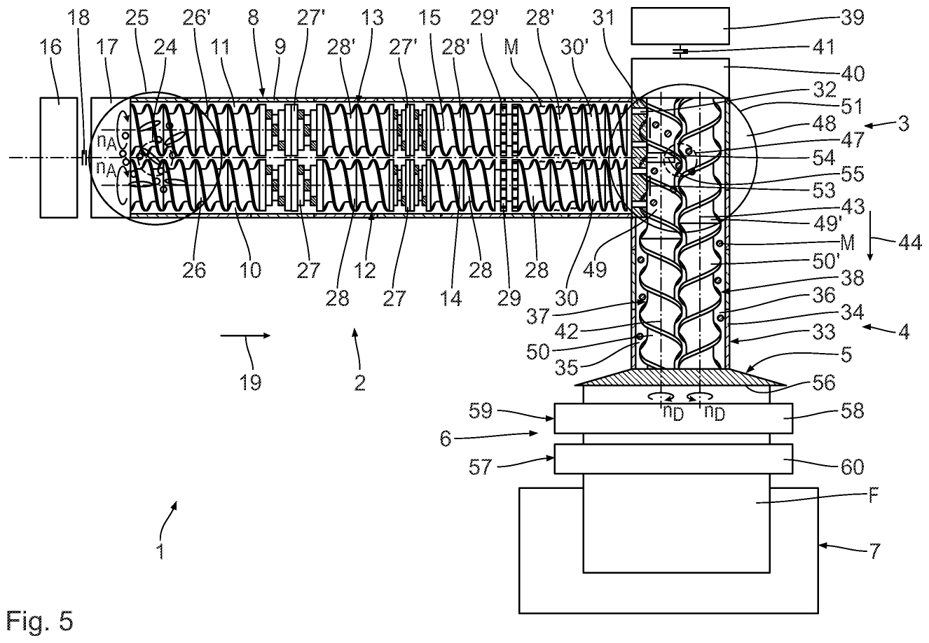

A fourth exemplary embodiment of the invention is described in the following with reference to FIG. 5. In line with the third exemplary embodiment, the pressure buildup screw machine 33 is designed as a counter-rotating two-shaft pressure buildup screw machine. In contrast to the third exemplary embodiment and in line with the second exemplary embodiment, the pressure buildup device 4 is disposed at an angle of 90° relative to the mixing device 2. With respect to further details about structure and operation, reference is made to the preceding exemplary embodiments.

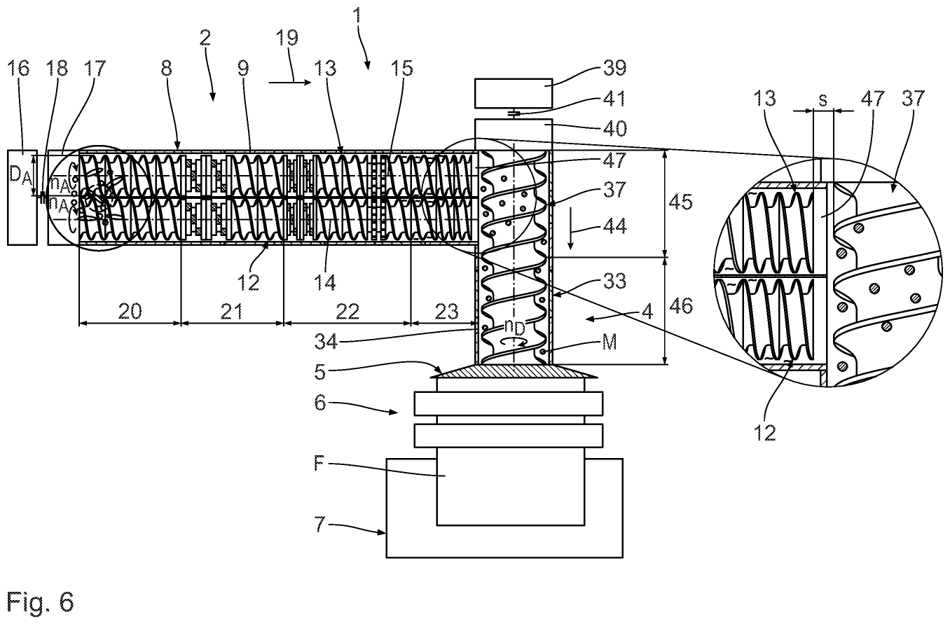

A fifth exemplary embodiment of the invention is described in the following with reference to FIG. 6. In contrast to the preceding exemplary embodiments, the mixing device 2 is directly connected to the pressure buildup device 4, and so there is no need for a connecting device. A discharge plate is not present. The feed opening 47 of the pressure buildup screw machine 33 is formed in the side of the housing 34. The housing 9 of the processing screw machine 8 is connected to the housing 34 of the pressure buildup screw machine 33. To this end, the pressure buildup device 4 or the pressure buildup screw machine 33 is disposed at an angle of 90° to the mixing device 2 or the processing screw machine 8.

In line with the preceding exemplary embodiments, the processing screw machine 8 is designed as a co-rotating two-shaft processing screw machine. In line with the first exemplary embodiment and the second exemplary embodiment, the pressure buildup screw machine 33 is designed as a single-shaft pressure buildup screw machine. The treatment element shafts 12, 13 have a distance s to the pressure buildup treatment element shaft 37. For s, in particular: 0.05 mm≤s≤10 D_{A}, in particular 0.1 mm≤s≤10·D_{A}, in particular 0.1 mm≤s≤5·D_{A}, and in particular 0.5 mm≤s≤D_{A}. With respect to further details about structure and operation, reference is made to the preceding exemplary embodiments.

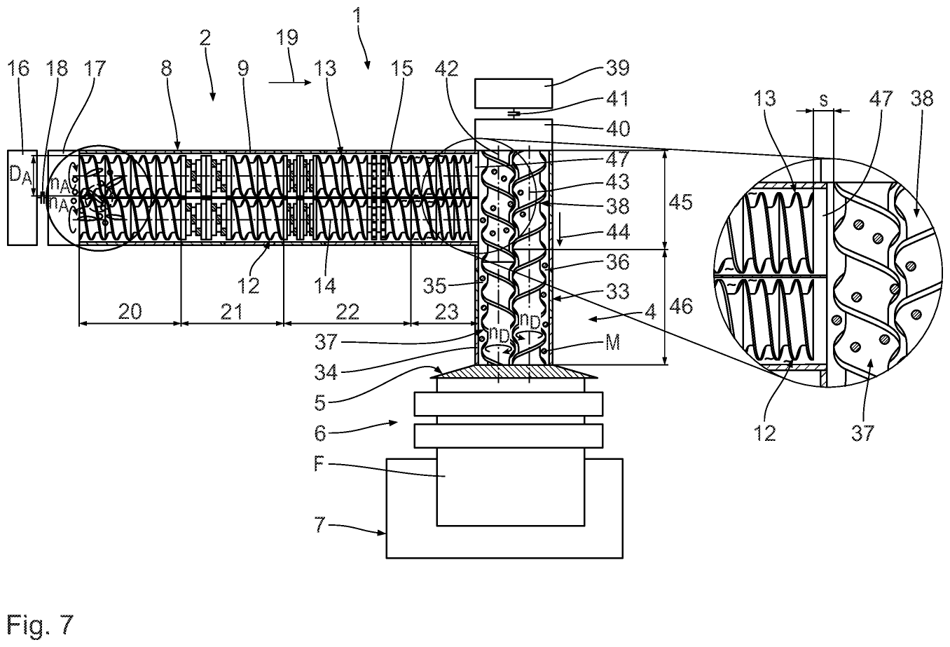

A sixth exemplary embodiment of the invention is described in the following with reference to FIG. 7. In line with the preceding exemplary embodiment, the mixing device 2 is directly connected to the pressure buildup device 4, and so there is no need for a connecting device. The housing 9 of the processing screw machine 8 is connected to the side of the housing 34 of the pressure buildup screw machine 33. To this end, the pressure buildup device 4 or the pressure buildup screw machine 33 is disposed at an angle of 90° relative to the mixing device 2 or the processing screw machine 8.

In line with the preceding exemplary embodiments, the processing screw machine 8 is designed as a co-rotating two-shaft processing screw machine. In line with the third exemplary embodiment and the fourth exemplary embodiment, the pressure buildup screw machine 33 is designed as a counter-rotating two-shaft pressure buildup screw machine. The pressure buildup treatment element shafts 37, 38 are disposed next to one another in a horizontal direction. The treatment element shafts 12, 13 have a distance s from the adjacent pressure buildup treatment element shaft 37. For the distance s, in particular: 0.05 mm≤s≤10·D_{A}, in particular 0.1 mm≤s≤10·D_{A}, in particular 0.1 mm≤s≤5 D_{A}, and in particular 0.5 mm≤s≤D_{A}. With respect to further details about structure and operation, reference is made to the preceding exemplary embodiments.

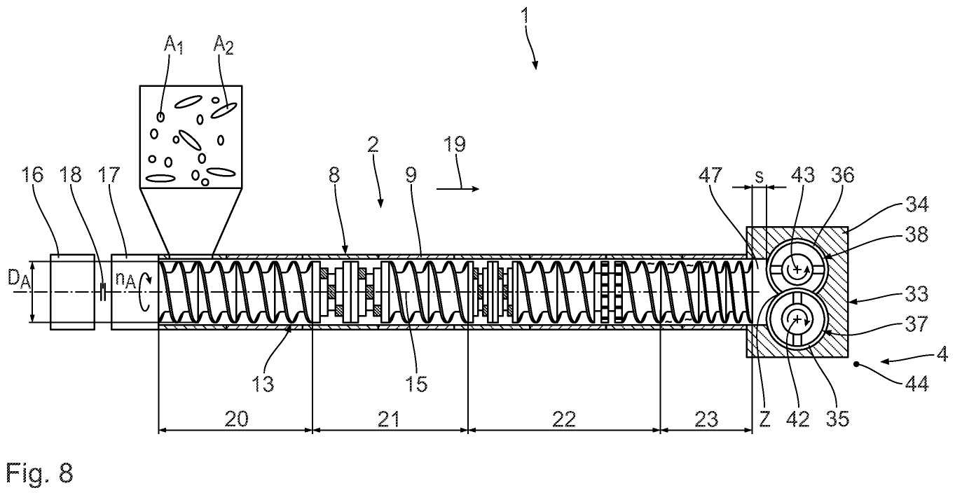

A seventh exemplary embodiment of the invention is described in the following with reference to FIG. 8. In contrast to the sixth exemplary embodiment, the pressure buildup treatment element shafts 37, 38 of the counter-rotating two-shaft pressure buildup screw machine 33 are disposed one above the other in a vertical direction. The treatment element shafts 12, 13 of the co-rotating two-shaft processing screw machine 8 have a distance s from the pressure buildup treatment element shafts 37, 38. The feed opening 47 is formed in an interstitial region Z of the pressure buildup treatment element shafts 37, 38. With respect to further details about structure and operation, reference is made to the preceding exemplary embodiments.

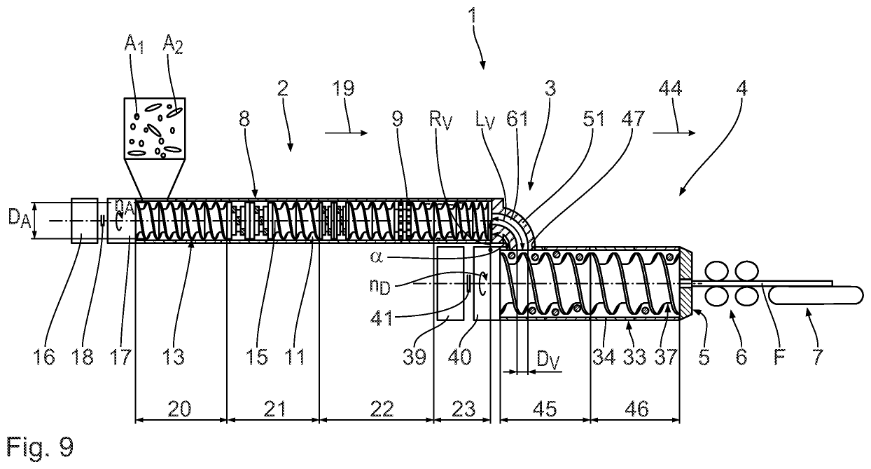

An eighth exemplary embodiment of the invention is described in the following with reference to FIG. 9. In contrast to the preceding exemplary embodiments, the connecting element 51 of the connecting device 3 is in the form of a pipe. The housing 9 of the processing screw machine 8 is not closed, and so the housing bores 10, 11 in the discharge zone 23 are directly connected to a channel 61 which is formed by the pipe. The housing 9 is disposed above the housing 34, and so the connecting element 51 is connected to an upper face of the housing 34 and leads to the feed opening 47. The energy storage material M is pushed from the processing screw machine 8 to the pressure buildup screw machine 33 through the pipe.

The channel 61 has a length L_{V} based on its central longitudinal axis. For the length L_{V}: 1≤L_{V}/D_{A}≤100, in particular 2≤L_{V}/D_{A}≤50, and in particular 4≤L_{V}/D_{A}≤10. Furthermore, the channel 61 has a radius of curvature R_{V} based on its central longitudinal axis. For the radius of curvature R_{V}, in particular: 0.5≤R_{V}/D_{A}≤10, in particular 1≤R_{V}/D_{A}≤7, and in particular 2≤R_{V}/D_{A}≤4. Moreover, the channel 61 forms an angle of curvature α between an inlet opening and an outlet opening. For the angle of curvature α, in particular: 1°≤α≤90°, in particular 5°≤α≤70°, and in particular 10°≤α≤50°. In the exemplary embodiment according to FIG. 9, the angle of curvature α=90°. The channel 61 or the pipe has an internal diameter D_{V}, where in particular: 0.5≤D_{V}/D_{A}≤10, in particular 0.8≤D_{V}/D_{A}≤5, and in particular 1≤D_{V}/D_{A}≤2.

With respect to further details about structure and operation, reference is made to the preceding exemplary embodiments.

In further exemplary embodiments, the connecting element 51 in the form of a pipe can be straight and leads to the side of the pressure buildup screw machine 33. In further exemplary embodiments, multiple connecting elements in the form of a pipe can be provided and they divide the energy storage material M into multiple partial streams which lead to the pressure buildup screw machine 33. The connecting elements 51 can be connected to an upper face and/or the side of the housing 34 of the pressure buildup screw machine 33. The mixing device 2 and the pressure buildup device 4 can be disposed in a straight line to one another or at an angle to one another, in particular at an angle of 90° to one another.

In general:

The mixing device 2 can comprise a single-shaft processing screw machine, a co-rotating multi-shaft processing screw machine and/or a counter-rotating multi-shaft processing screw machine. In particular, a multi-shaft processing screw machine is designed as a two-shaft processing screw machine.

The pressure buildup device 4 can comprise a single-shaft pressure buildup screw machine, a counter-rotating multi-shaft pressure buildup screw machine and/or a co-rotating multi-shaft pressure buildup screw machine. A multi-shaft pressure buildup screw machine is in particular designed as a two-shaft pressure buildup screw machine.

The individual features of the exemplary embodiments described can be combined with one another in any manner

What is claimed is:

1. A processing system for processing an energy storage material comprising
a mixing device for processing the energy storage material,
wherein a pressure buildup device is disposed downstream of the mixing device in order to increase a pressure of the energy storage material.

2. The processing system according to claim 1,
wherein the mixing device comprises a processing screw machine.

3. The processing system according to claim 2,
wherein the processing screw machine comprises at least one treatment element shaft having a length L_{A} and an external diameter D_{A}, where: 20≤L_{A}/D_{A}≤60.

4. The processing system according to claim 1,
wherein the pressure buildup device comprises a pressure buildup screw machine.

5. The processing system according to claim 4,
wherein the pressure buildup screw machine comprises at least one pressure buildup treatment element shaft having a length L_{D} and an external diameter D_{D}, where: 3≤L_{D}/D_{D}≤40.

6. The processing system according to claim 1,
wherein the pressure buildup device comprises a single-shaft pressure buildup screw machine.

7. The processing system according to claim 1,
wherein the pressure buildup device comprises a multi-shaft pressure buildup screw machine.

8. The processing system according to claim 4,
wherein the pressure buildup screw machine comprises an intake zone and a pressure buildup zone.

9. The processing system according to claim 1,
wherein the mixing device comprises a processing screw machine having at least one treatment element shaft and the pressure buildup device comprises a pressure buildup screw machine having at least one pressure buildup treatment element shaft, wherein for a ratio of an external diameter D_{A} of the at least one treatment element shaft to an external diameter D_{D} of the at least one pressure buildup treatment element shaft: ⅕ ≤D_{A}/D_{D}≤3.

10. The processing system according to claim 1,
wherein the mixing device has at least one discharge opening which is disposed above a feed opening of the pressure buildup device.

11. The processing system according to claim 1,
wherein a connecting device is disposed between the mixing device and the pressure buildup device in order to feed the energy storage material to the pressure buildup device.

12. The processing system according to claim 1,
wherein the mixing device and the pressure buildup device are connected to one another in order to feed the energy storage material to the pressure buildup device.

13. The processing system according to claim 1,
wherein an extrusion tool is disposed downstream of the pressure buildup device.

14. A method for processing an energy storage material comprising the steps of:
providing a processing system for processing an energy storage material according to claim 1,
processing the energy storage material by means of the mixing device,
discharging the energy storage material from the mixing device and feeding the energy storage material to the pressure buildup device,
increasing a pressure of the energy storage material by means of the pressure buildup device, and
discharging the energy storage material from the pressure buildup device.
